(19) United States
(12) Patent Application Publication
(10) Pub. No.: US 2019/0212682 A1
(43) Pub. Date: Jul. 11, 2019

(54) IMAGE FORMING APPARATUS

(71) Applicant: CANON KABUSHIKI KAISHA, Tokyo (JP)

(72) Inventors: Yasuhiro Kawasaki, Yokohama-shi (JP); Chitose Tempaku, Numazu-shi (JP); Yuki Nishizawa, Yokohama-shi (JP)

(21) Appl. No.: 16/238,225

(22) Filed: Jan. 2, 2019

(30) Foreign Application Priority Data
Jan. 10, 2018 (JP) 2018-001605

(51) Int. Cl. G03G 15/20; G03G 15/16; G03G 15/06; G03G 15/00

(52) U.S. Cl. CPC G03G 15/2053; G03G 15/6558; G03G 15/065; G03G 15/16

(57) ABSTRACT

An image forming apparatus includes an image forming portion configured to form a toner image on a recording material; a fixing portion configured to fix the toner image on the recording material by heating the toner image formed on the recording material; a flow path including a first space connecting with the fixing portion and a second space connecting with the first space and through which air discharged from the fixing portion passes; a first electrode portion provided in the first space and provided with a first potential; and a second electrode portion provided in the second space and provided with a second potential different from the first potential. An air speed of the air passing through the second space is slower than an air speed of the air passing through the first space.

### FIELD OF THE INVENTION AND RELATED ART

The present invention relates to an image forming apparatus.

In an image forming apparatus, such as a copying machine, a printer or a facsimile machine, employing an electrophotographic type or the like, a fixing device (fixing portion) for fixing an unfixed toner image, formed on a recording material, on the recording material by high-temperature heating is provided. By this high-temperature heating in the fixing device, a volatile substance generates from a parting wax principally contained in toner and suspends and scatters around in some instances.

In recent years, with raised awareness of environmental (ecological problems, it is desired that generation of ultrafine particles (UFP) is also suppressed. The UFP refers to particles of not more than 100 nm in diameter of a suspended particulate matter (SPM) is general. In The Blue Angel which is a standard of a so-called eco-label issued to environmentally friendly products in Federal Republic of Germany, the UFP is defined as particles of 7 nm-300 nm in diameter.

As a technique for reducing discharge (emission) of the UFP, Japanese Laid-Open Patent Application (JP-A) 2015-191156 discloses a technique such that an accumulating space other than a feeding space is provided downstream of a fixing nip with respect to a feeding direction of the recording material. Further, JP-A 2010-2803 discloses a technique such that an electrostatically collecting means for electrostatically collecting the UFP is provided.

Further, it has been known a tendency that fine particles of 1-20 μm in diameter can be collected with high efficiency by the electrostatically collecting technique, but collecting efficiency for sub-micron particles of less than 1 μm in particle size lowers (Static Electricity Handbook (JSBN4-27403510-7), Ohmsha, Ltd.). The reason is that is becomes difficult to move the particles by electrostatic force since the electrostatic force acting on the sub-micron particles is small and the influence of viscosity resistance of gas becomes large.

In the future, there is a liability that a printing speed is improved with improvement in productivity of the image forming apparatus and thus an amount of discharge per unit toner image of the UFP increases. Accordingly, a collecting technique with high collecting efficiency for the UFP has been required.

A constitution in which the UFP is collected by accumulating the UFP generated and by absorbing the UFP on a surface forming the accumulating space has been proposed (JP-A 2015-191156). This collecting technique uses a phenomenon such that when the UFP contacts a high-temperature portion, the UFP is liquefied and then is deposited and therefore there is a need to increase a temperature of a wall on which the UFP is to be deposited. That is, the UFP cannot be collected until the temperature of the surface (wall) reaches a predetermined temperature. Accordingly, when further improvement in productivity of the image forming apparatus is taken into consideration, in this collecting technique, further improvement has been required in order to improve the collecting efficiency particularly at the toner image of actuation of the image forming apparatus.

On the other hand, in an image forming apparatus disclosed in JP-A 2010-2803, a constitution in which the UFP is collected using the electrostatic collecting technique has been proposed. The electrostatic collecting technique is a technique such that the UFP is actively collected by imparting the electrostatic force to the UFP. However, as described in the Static Electricity Handbook, there is a tendency that the collecting efficiency for the sub-micron particles of less than 1 μm in particle size lowers. Accordingly, in this electrostatic collecting technique, further improvement has been required in order to improve the collecting efficiency for the sub-micron particles of less than 1 μm in particle size.

Incidentally, in order to enhance the collecting efficiency of the electrostatic collecting technique, a technique such that a particle size of the UFP is increased using an UFP agglomerating means (cyclone collecting means) before the UFP passes through the electrostatic collecting means is also disclosed. The UTP agglomerating means (cyclone collecting means) is a technique (means) such that the OFP is guided into a space (UFP agglomerating space) in which a high-speed eddy circumference and is agglomerated using centrifugal force. However, the UFP agglomerating means (cyclone collecting means) needs a fan for generating the high-speed eddy circumference and the UFP agglomerating space, and therefore, there arise problems such as an increase in cost and upsizing of the collecting device (means).

### SUMMARY OF THE INVENTION

A principal object of the present invention is to provide an image forming apparatus capable of meeting improvement in productivity of the image forming apparatus by efficiently collecting ultra-fine particles generating in the image forming apparatus while employing a simple apparatus (device) constitution.

According to an aspect of the present invention, there is provided an image forming apparatus comprising: an image forming portion configured to form a toner image on a recording material; a fixing portion configured to fix the toner image on the recording material by heating the toner image formed on the recording material; a flow path including a first space connecting with the fixing portion and a second space connecting with the first space and through which air discharged from the fixing portion passes; a first electrode portion provided in the first space and provided with a first potential; and a second electrode portion provided in the second space and provided with a second potential different from the first potential, wherein an air speed of the air passing through the second space is slower than an air speed of the air passing through the first space.

According to another aspect of the present invention, there is provided an image forming apparatus comprising: an image forming portion configured to form a toner image on a recording material; a fixing portion configured to fix the toner image on the recording material by heating the toner image formed on the recording material; a flow path including a first space connecting with the fixing portion and a second space connecting with the first space and through which air discharged from the fixing portion passes; a first electrode portion provided in the first space and provided with a first potential; and a second electrode portion provided in the second space and provided with a second potential different from the first potential, wherein a cross sectional area of the second space with respect to a direction perpendicular to a direction of the air entering the second space is larger than a cross sectional area of the first space with respect to a direction perpendicular to a direction of the air entering the first space.

Further features of the present invention will become apparent from the following description of exemplary embodiments with reference to the attached drawings.

### BRIEF DESCRIPTION OF THE DRAWINGS

FIG. 1 is a longitudinal sectional view of a main assembly of an image forming apparatus according to an embodiment of the present invention.

FIG. 2 is a detailed sectional view of a fixing device in the embodiment.

Part (a) of FIG. 3 is a longitudinal sectional view of an fixing device and a UFP collecting means in First Embodiment, and part (b) of FIG. 3 is a top view of the fixing device and the UFP collecting means in First Embodiment.

FIG. 4 is a perspective view of a charging means 200b.

FIG. 5 is a schematic view of Brownian diffusion movement.

Part (a) of FIG. 6 is a longitudinal sectional view of an fixing device and a UFP collecting means in First Embodiment, and part (b) of FIG. 6 is a top view of the fixing device and the UFP collecting means in Comparison Example 2.

FIG. 7 is a graph for illustrating a result of an effect confirmatory experiment of First Embodiment.

Part (a) of FIG. 8 is a longitudinal sectional view of an fixing device and a UFP collecting means in Second Embodiment, and part (b) of FIG. 8 is a top view of the fixing device and the UFP collecting means in Second Embodiment.

FIG. 9 is a longitudinal sectional view of a main assembly of an image forming apparatus in Third Embodiment.

Part (a) of FIG. 10 is a longitudinal sectional view of an fixing device and a UFP collecting means in Third Embodiment, and part (b) of FIG. 10 is a top view of the fixing device and the UFP collecting means in Third Embodiment.

### DESCRIPTION OF EMBODIMENTS

Embodiments of the present invention will be described specifically with reference to the drawings.

### First Embodiment

### (Image Forming Apparatus)

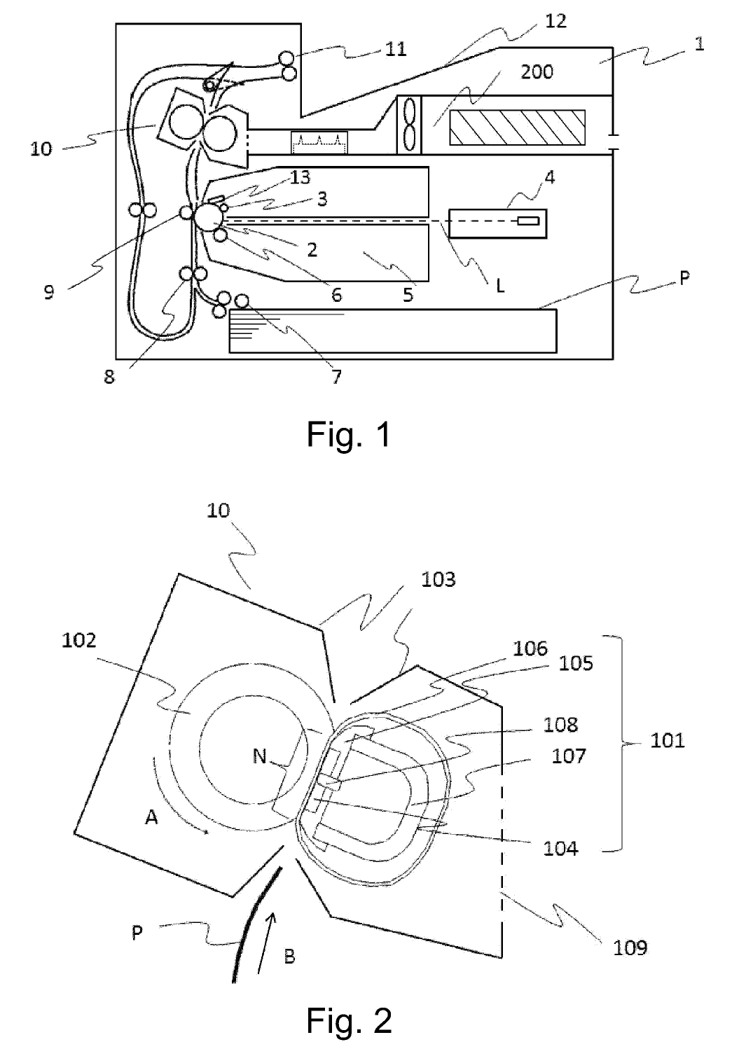

FIG. 1 is a schematic sectional view of an image forming apparatus according to First Embodiment of the present invention. Incidentally, the present invention is not limited thereto, but may also be widely applicable to image forming apparatuses of other types.

An image forming apparatus 1 is a laser beam printer using an electrophotographic process. A photosensitive drum 2 as an image bearing member is rotationally driven at a predetermined peripheral speed and is electrically charged to a predetermined polarity and a predetermined potential by a charging roller 3. A laser beam scanner 4 as an exposure means outputs laser light L modulated depending on image information sent from a CPU and subjects the drum 2 to scanning exposure. By this scanning exposure, an electrostatic latent image is formed. A developing device 6 includes a developing roller 6 from which toner is supplied to a surface of the drum 6, so that the electrostatic latent image is developed into a toner image.

On the basis of a sheet (paper) feeding start signal, a sheet feeding roller 7 is driven, so that a recording material (recording paper) P is separated and fed one by one. The recording material P passes through a registration roller pair 8 and is guided through the registration roller pair 8 into a transfer nip, at predetermined timing, formed by the drum 2 and a transfer roller 9. The transfer roller 9 transfers the toner image from the surface of the drum 2 onto a surface of the temperature P under application of a transfer bias voltage of a polarity opposite to a charge polarity of the toner. Thereafter, the recording material P is subjected to a fixing process of the toner image by a fixing device (fixing portion) 10 and is fed to a sheet discharging roller pair 11, and then is discharged onto a sheet discharge tray 12.

On the other hand, the surface of the drum 2 is cleaned by bringing a cleaning device 13 provided with a cleaning blade into contact with the drum 2 so that a free end of the cleaning blade is oriented toward an upstream side of a rotational direction of the drum 2 (counter contact), and then is repetitively subjected to an image forming operation. In the image forming apparatus 1, a UFP collecting means 20 for collecting UFP (ultra-fine particles) of less than 100 nm in particle size generated in the fixing device 10 is provided. The UFP collecting means 200 for forming a flow path forming portion described specifically later is disposed with respect to a direction crossing a feeding direction of the recording material in the fixing device 10.

### (Fixing Device)

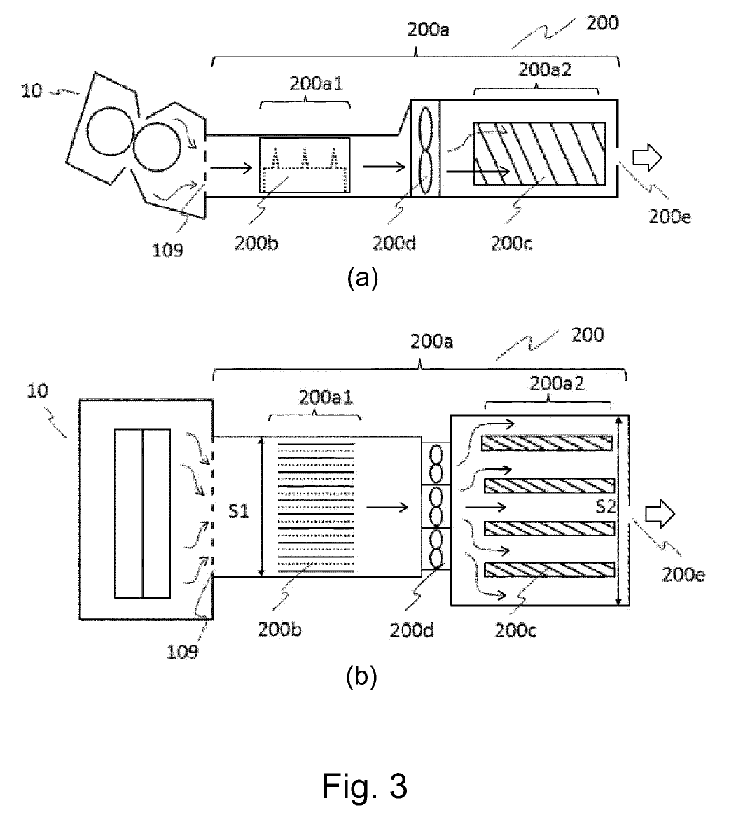

In the following, a detailed structure of the fixing device 10 will be described with reference to FIG. 2. In the fixing device 10, a heating unit 101 and a rotatable pressing member 102 are provided and accommodated in a casing 103.

The heating unit 101 includes a heater 104 as a heating means. This heater 104 is supported by a heather holder 105 as a supported member. A sleeve-like fixing sleeve (fixing film) 106 as a rotatable heating member is fitted around the heater holder 105. For this reason, the heater holder 105 is formed of a heat-resistant resin material such as a liquid crystal polymer or the like having a heat-resistant property and a sliding property so as to guide the fixing sleeve 106. The fixing sleeve 106 includes a base layer made of metal such as SUS which resists thermal and mechanical stresses and which has a good thermal conductivity. On the base layer, a PFA (perfluoroalkoxy) resin material is applied in a layer, and ensures a parting property for ensuring a separation performance.

The pressing roller 102 includes a core metal, an elastic layer formed with a silicone rubber or the like, and a surface layer coated on the elastic layer with the PFA resin material excellent in parting property similarly as in the case of the fixing sleeve. A metal stay 107 presses the heater holder 105 and the heater 104 toward the pressing roller 102 through the fixing sleeve 106, so that a fixing nip N is formed. The heater 104 is heated by energization by subjecting an unshown energizing means to on-off control. A thermistor 108 as a temperature detecting means contacts the heater 104, and on the basis of a detection temperature thereof, the heater 104 is temperature-controlled to a predetermined target set temperature.

The set temperature in this embodiment is 180° C. In this state, when the pressing roller 102 is rotated in an arrow A direction, the fixing sleeve 106 receives a frictional force of an outer peripheral surface thereof at the nip N, and the frictional force of the outer peripheral surface overcomes a frictional force of an inner peripheral surface thereof, so that the fixing sleeve 106 is rotated by the pressing roller 106. The recording material P on which the unfixed toner image is carried is guided into the nip N in a feeding direction (arrow B direction), and then is nipped and fed through the nip N. In this feeding process, heat of the heater 104 is imparted to the recording material P through the fixing sleeve 106, so that the toner image is fixed on the recording material P.

### (UFP Generating Mechanism)

The toner contains a hydrocarbon parting wax such as paraffin wax, polyethylene wax or polypropylene wax. The parting wax bleeds from an inside of the toner when the toner is deformed (crushed) by heat and pressure of the fixing nip N. A melting point of the parting wax is set at 76° C., for example, and when a temperature of the parting wax becomes the melting point or more, the parting wax is melted and enters a boundary between the toner and the surface of the fixing sleeve 106. The melted parting wax prevents the melted toner to deposit and remain on the fixing sleeve 106.

A part of this parting wax does not remain in a liquid shape but is vaporized and moves white riding an air flow in a casing 103. The parting wax which has been vaporized condenses again and becomes the UFP of less than 0.1 μm in particle size.

### (UFP Collecting Means)

### 1) UFP Collecting Means Air Flow

The image forming apparatus 1 shown in FIG. 1 includes a UFP collecting means 200. As shown in FIG. 2, the casing 103 is provided with an opening 109 at a surface opposing the fixing sleeve 106. The size of the opening 109 is 20 mm×220 mm. By providing the opening 109, the UFP generating in the fixing device 10 can be guided to the UFP collecting means 200. When the substrate of the opening 109 is such that a width (220 mm) with respect to a longitudinal direction is equal to or more than a length of a printing region, the UFP can be efficiently guided. Here, the longitudinal direction is a direction perpendicular to the recording material feeding direction. In this embodiment, a constitution in which a lattice-like plate material is provided in the opening 109 was employed. The lattice-like plate material has a mesh sufficiently larger than the UFP and is 50% or more in aperture ratio.

Part (a) of FIG. 3 is a longitudinal sectional view of the fixing device 10 and the UFP collecting means 200 and part (b) of FIG. 3 is a top view of the fixing device 10 and the UFP collecting means 200. The UFP collecting means 200 is constituted by a suction opening in the neighborhood of the fixing device 10, an exhaust opening 200e leading to an outside of the image forming apparatus 100, an exhaust duct (flow path forming portion) 200a ranging from the suction opening to the exhaust opening 200e, a charging means 200b, a collecting electrode 200c and a fan 200d for discharging the air.

When the fan 200d is rotated, the UFP generated in the fixing device 10 passes through the opening 109 and is guided in an arrow direction in the exhaust duct 200a through the suction opening. The air containing the guided UFP passes through a charging space (first space) 200a1 in which the charging means 200c is disposed. Then, the air passes through a collecting space (second space) 200a1 in which the collecting electrode 200c is disposed, and is discharged (exhausted) to the outside of the apparatus. Thus, the flow path forming portion prepared by forming the charging space 200a1 and the collecting space 200a2 through which the air discharged from the fixing device 10 is successively passed is formed.

In this embodiment, the exhaust duct 200a is all formed of a resin material, and the suction opening is disposed in the neighborhood of the lattice-like opening 109 of the fixing device 10 and had a section of 25 mm×230 mm. A size S1 of a cross section of the charging space 200a1 with respect to a traveling direction of the air was 25 mm×230 mm which is the same as the size of the suction opening. Further, a size of a cross section of a mounting portion of the fan 200d with respect to the air traveling direction was 60 mm×180 mm, and a size S2 of a cross size of the collecting space 200a2 with respect to the air traveling direction was 60 mm×200 mm which is larger than the size S1 of the cross size of the charging space 200a1.

The sizes of the cross sizes in the exhaust duct 200a are summarized in Table 1 below. As the fan 200d, three 60 mm-square axial fans were used and arranged in parallel.

TABLE 1

| | Size of cross section |
|---|---|
| Suction opening | 25 mm × 230 mm (=0.00575 m²) |
| Charging space 200a1 | 25 mm × 230 mm (=0.00575 m²) |
| Mounting portion of fan 200d | 60 mm × 180 mm (=0.0108 m²) |
| Collecting space 200a2 | 60 mm × 300 mm (=0.018 m²) |

### 2) Charging Space 200a1

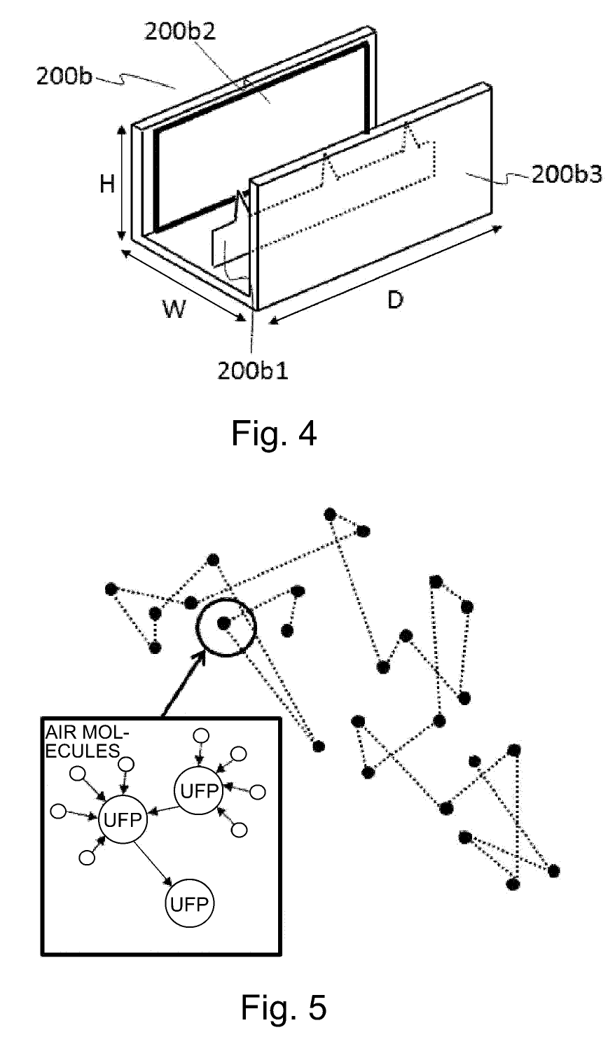

FIG. 4 is a perspective view of the charging means 200b provided in the charging space 200a1. In this embodiment, in the charging space 200a1, a first electrode (first electrode portion) 200b1 provided with a first potential and a second electrode 200b2 are provided opposed to each other as a pair. A plurality of pairs each consisting of the first electrode 200b1 and the second electrode 200b2 are provided along a direction crossing the flow path (part (b) of FIG. 3).

In FIG. 4, a metal plate provided with mountain-like projections which are equidistantly disposed is the first electrode 200b1, and a flat metal plate is the second electrode 200b2. These first and second electrodes 200b1 and 200b2 are disposed opposed to each other. Further, the first and second electrodes 200b1 and 200b2 are positioned by a case 200b3 formed of an insulating material. In this embodiment, a size of the charging means 200b was a width W=12 mm, a height H=20 mm and a depth D=40 mm.

The first electrode 200b1 is formed of aluminum, stainless steel or the like in a thickness of 0.1 mm-1.0 mm, and a high voltage is applied thereto. The second electrode 200b2 is formed of aluminum, stainless steel or the like in a thickness of 0.1 mm-1.0 mm, and is grounded. In this embodiment, a 0.1 mm-thick stainless plate was used as the first electrode 200b1 and a 0.3 mm-thick aluminum plate was used as the second electrode 200b2. Further, the charging means 200b was disposed so that the first electrode 200b1 is parallel to the flow of the air in the charging space 200a1.

Here, a mechanism for electrically charging the UFP will be specifically described. Between the first electrode 200b1 and the second electrode 200b2, a voltage from +1 kV to +20 kV or from −1 kV to −20 kV is applied (in this embodiment, a voltage of −3.2 kV was applied to the first electrode 200b1). As a result, a non-uniform electric field generates at a periphery of peaks of the mountain-like projections, so that continuous corona discharge generates. In the neighborhood of the electrode causing the corona discharge, electrons are attracted toward a side where a potential is high and are accelerated.

The electrons collide with molecules of the air, so that electrons are successively supplied from the collided molecules. The supplied electrons also increase the number thereof while repeating acceleration and collision, so that electron avalanche generates. When the air containing the UFP is passed through this region, the UF can be electrically charged.

In the region 8space) in which the electron avalanche generates, the UFP is passed charged as many as possible, and therefore in this embodiment, the charging means is disposed in parallel in the charging space 200a1.

In this embodiment, the size of the suction opening and the size S1 of the cross section of the charging space 200a1 were the same, but is also possible to make the size S1 of the cross section of the charging space 200a1 larger than the size of the suction opening. The reason therefor is that in order to charge the UFP, passing of the UFP through the region of the electron avalanche is condition therefor and dependence of the UFP passing through the region on the space is relatively small. By decreasing the size S1 of the cross section of the charging space 200a1, the number of the charging means 200b arranged in parallel can be reduced and the charging space 200a1 can be disposed more freely.

### 3) Collecting Space 200a2

Using FIG. 3, the collecting space 200a2 will be described. As the collecting electrode 200c used as the second electrode portion which is provided in the second space and which provides a second potential different from the above-described first potential, a flat metal plate was used in this embodiment. The collecting electrode 200c is formed of aluminum, stainless steel or the like. In this embodiment, four 1.0 mm-thick aluminum plates each having a size of 25 mm×150 mm were arranged in the collecting space 200c1 so as to extend along and in parallel to the flow of the air. An arrangement direction of the collecting electrodes 200c is such that the collecting electrodes 200c are provided in the collecting space 200a2 so as to cross a direction of the flow of the air, and a direction in which the collecting electrodes 200c extend toward an upstream side with respect to the air flowing direction is set so as to form an angle of 45° or less between itself and the air flowing direction.

Here, the reason why the size S2 of the cross section of the collecting space 200a2 shown in Table 1 is made larger than the size S1 of the cross section of the charging space 200a1 will be specifically described. A Comparison Example principle of general electrostatic collection is such that the charged particles are moved to collecting electrode surfaces by an electrostatic force F(N) (F=qE) by an electric field E(N/C) formed between the collecting electrode and the particles charged to an electric charge q(C) and are collected at the collecting electrode surfaces.

In general, by the electrostatic collection, fine particles of 1 μm-20 μm in particle size can be collected with high efficiency, but there is a tendency that collecting efficiency for sub-micron particles of less than 1 μm in particle size lowers. As the reason therefor, it is possible to cite that a flowability of the particles to the air flow becomes high and movement of the particles by the electrostatic force becomes difficult. Particularly, most of the UFP generating in the image forming apparatus is 0.1 μm or less in particle size, and therefore, it is not easy to achieve high collecting efficiency in normal electrostatic collection.

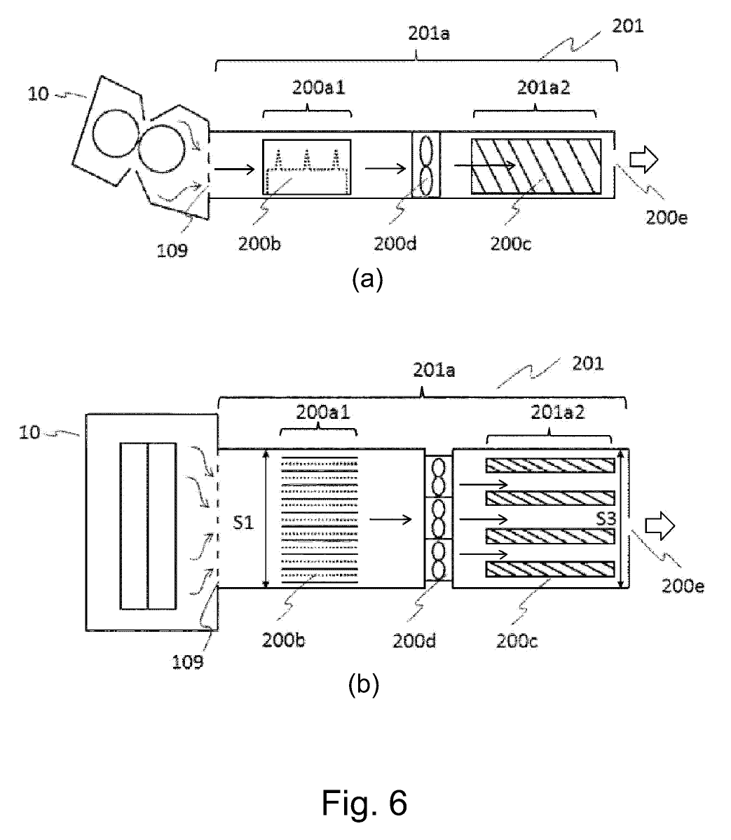

Therefore, in this embodiment, a constitution in which a moving space of the gas (air) is lowered in the collecting space and thus the UFP passes through the collecting space in a long time was employed. The reason therefor will be described specifically. As shown in FIG. 5, gas (air) molecules always collide with the UFP. The UFP of 0.1 μm or less in particle size moves and diffuses by the collision of the molecules. This is called Brownian diffusion motion. When the collecting electrodes are placed in the collecting space, the UFP causes Brownian diffusion movement and approaches the collecting electrodes. In the case where the UFP is charged at this time, the electrostatic force acting on the UFP becomes larger than a viscosity resistance of the gas (air) against the OFP, so that the UFP can be deposited on the collecting electrode surfaces.

As a result, on the collecting electrode surfaces, a concentration (density) of floating UFP decreases, so that a concentration gradient generates in the neighborhood of the collecting electrodes. By this concentration gradient, the ambient UFP diffuses in a collecting electrode direction and thus approaches the collecting electrodes. By repeating this cycle, the UFP can be collected with high efficiency. A movement space of this Brownian diffusion is relatively small (slow) (about 1 mm/sec), and therefore, there is a need to lower the UFP movement space and to cause the UFP to pass through the collecting space for a long time.

This embodiment is constituted in view of the above, and as a means for causing the UFP to pass through the collecting space 200a2 for a long time, by making the size 2 of the cross section of the collecting space 200a2 larger than the size S1 of the cross section of the charging space 200a1, the space of the charged UFP is slowed.

In the following, size and air speeds (wind spaces) in this embodiment will be specifically described. The air speeds in the charging space 200a1 and the collecting space 200a2 in this embodiment were measured. The air speed causes a distribution in the space, and therefore, the air speed in this embodiment was an average air speed in the space. In order to check the average air speed in each of the charging space 200a1 and the collecting space 200a2, the air speed was measured so that all the air flow passes through an anemometer in the neighborhood of the charging means 200b and at the exhaust opening 200e.

The air speed was measured using a Vane anemometer (“Testo 410-2”, manufactured by Testo Se & Co. KGaA). The volume of the air flowing in each of the charging space 200a1 and the collecting space 200a2 was calculated by multiplying the resultant air speed by a size of a cross section of the anemometer. Then, the average air speed was acquired by dividing the resultant air volume by the size S1 of the cross size of the charging space 200a1 or by the size S2 of the cross size of the collecting space 200a2. The sizes of the cross sections of the charging space 200a1 and the collecting space 200a2 and the average air speeds are summarized in Table 2. As shown in Table 2, in this embodiment, it was confirmed that the average air speed in the collecting space 200a2 is slower than the average air speed in the charging space 200a1 so as to be about 30% of the air speed in the charging space 200a1.

TABLE 2

| Space | Size of cross section | AAS*³ |
|---|---|---|
| CHS*¹ 200a1 | 25 mm × 230 mm (=0.0057 m²) | 1.53 m/s |
| COS*² 200a2 | 60 mm × 300 mm (=0.018 m²) | 0.48 m/s |

*¹“CHS” is the charging space.
*²“COS” is the collecting space.
*³“AAS” is the average air speed.

### (Confirmation of Effect)

A method of confirming an effect of this embodiment will be specifically described. The image forming apparatus 1 is placed in a chamber of 2 m³ in volume, and images with a print ratio of 5% were continuously printed on the recording materials for 200 seconds. At that time, the concentration of the UFP in the chamber was measured using nano-particle size distribution measuring device (“FMPS 3019”, manufactured by TSI Incorporated).

### 1) This Embodiment

This embodiment is based on the premise that the image forming apparatus has a structure of the exhaust duct 200a in which the size S1 of the collecting space section of the charging space 200a1 with respect to the air traveling direction is 25 mm×230 mm and the size S2 of the cross section of the collecting space 200a2 with respect to the air traveling direction is 50 mm×300 mm. An image forming operation was carried out under application of a voltage of −3.2 kV to the first electrode 200b1.

### 2) Comparison Example 1

In Comparison Example 1, the image forming apparatus having a structure of the exhaust duct 200a in which the size S1 of the collecting space section of the charging space 200a1 with respect to the air traveling direction is 25 mm×230 mm and the size S2 of the cross section of the collecting space 200a2 with respect to the air traveling direction is 50 mm×300 mm was used. In Comparison Example 1, different from First Embodiment, an image forming operation was carried out with no application of the voltage.

### 3) Comparison Example 2

Comparison Example 2 is different from First Embodiment in size of a cross section of a collecting space with respect to the air traveling direction, and is the same as First Embodiment except for this point. Part (a) of FIG. 6 is a longitudinal sectional view of a heat 10 and a UFP collecting means 201, and part (b) of FIG. 6 is a top view of the fixing device 10 and the UFP collecting means 201. In Comparison Example 2, the size S1 of the collecting space section of the charging space 200a1 with respect to the air traveling direction is 25 mm×230 mm and the size S2 of the cross section of a collecting space 201a2 with respect to the air traveling direction is also 25 mm×230 mm which is the same as the size S1 of the charging space 200a1.

By using an image forming apparatus including an exhaust duct 201a having the above-described structure, the image forming operation was carried out under application of the voltage of −3.2 kV to the first electrode 200b1 similarly as in First Embodiment. Incidentally, the average air speed of the air passing through the charging space 200a1 in Comparison Example 2 is equal to the average air speed of the air passing through the charging space 200a1 in First Embodiment.

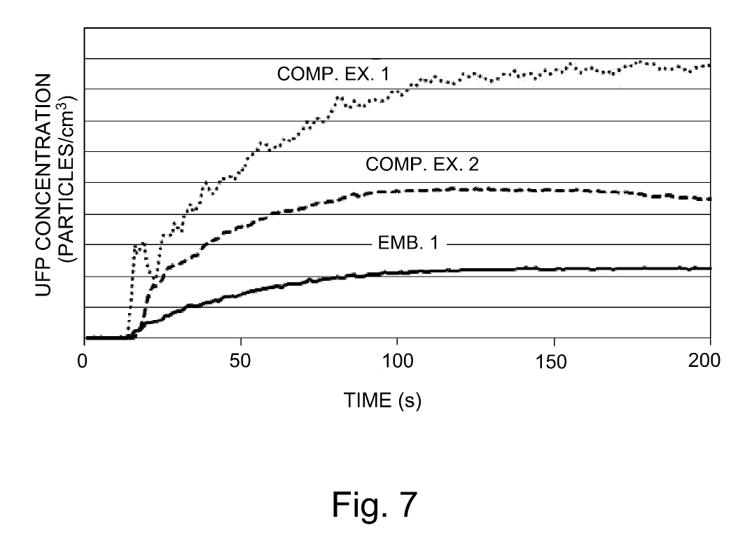

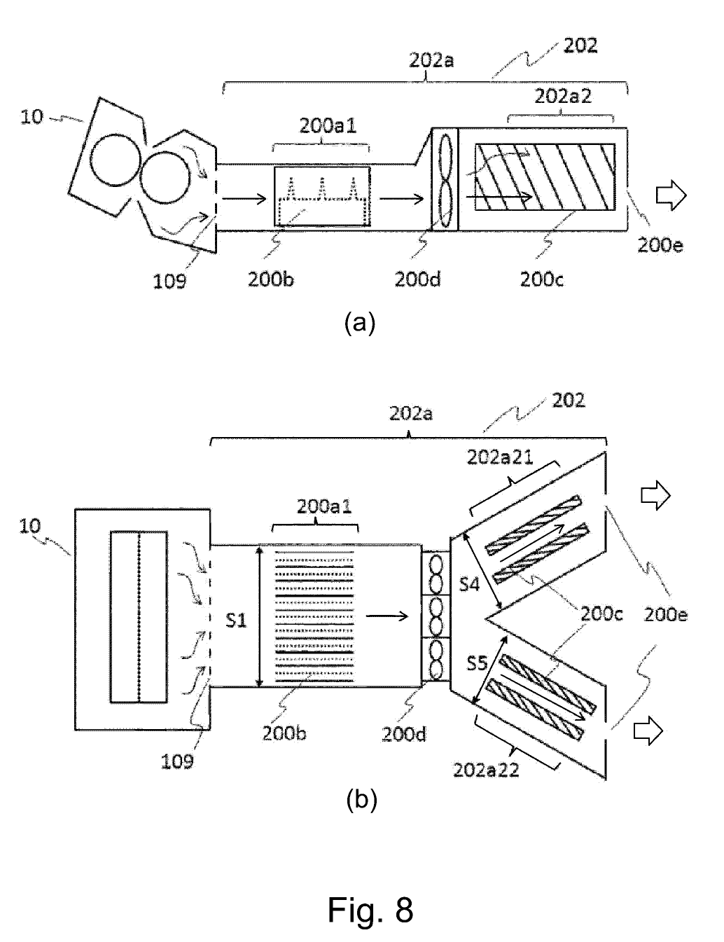

Measurement result for the above-described image forming apparatuses are shown in FIG. 7. In FIG. 7, the abscissa represents a time(s), and the ordinate represents the number of the UFP per 1 cm³ (UFP concentration) (particles/cm³). Further, parameters and results relating to Comparison Example 1, Comparison Example 2 and First Embodiment (this embodiment) are shown in Table 3. When Comparison Example 2 and Comparison Example 2 are compared with each other, in Comparison Example 2, the UFP was able to be collected by 45% compared with that in Comparison Example 1 by providing the electrostatic collecting means. Further, when Comparison Example 2 and First Embodiment (this embodiment) are compared with each other, the UFP Comparison Example efficiency was able to further enhanced by making the air speed in the collecting space in First Embodiment slower than that in Comparison Example 2 so as to be about 30% of the air speed in the collecting space in Comparison Example 2.

As described above, by employing a constitution in which the size of the cross section of the collecting space is made larger than the size of the cross section of the charging space, the UFP is capable of being collected efficiently.

TABLE 3

| | | | | | | UFP COLECTING |
|---|---|---|---|---|---|---|
| | CHRGING SPACE | | | COLLECTING SPACE | | EFFICIENCY |
| EMB OR | | | AVERAGE | | AVERAGE | COMPARED |
| COMP. EX | VOLTAGE | SIZE OF CROSS SECTION | AIR SPEED | SIZE OF CROSS SECTION | AIR SPEED | WITH COMP. EX. 1 |
| COMP. EX. 1 | 0 kV | 25 mm × 230 mm (0.00575 m²) | 1.53 m/s | 60 mm × 300 mm (0.018 m²) | 0.48 m/s | — |
| COMP. EX. 2 | −3.2 kV | 25 mm × 230 mm (0.00575 m²) | 1.53 m/s | 25 mm × 230 mm (0.00575 m²) | 1.53 m/s | 45% |
| EMB. 1 | −3.2 kV | 25 mm × 230 mm (0.00575 m²) | 1.53 m/s | 60 mm × 300 mm (0.018 m²) | 0.48 m/s | 80% |

Incidentally, in this embodiment, as the first electrode 200b1 of the charging means, the metal plate provided with the mountain-like projections which are equidistantly disposed was used, but a metal wire may also be used.

Further, in this embodiment, the collecting electrode 200c as the second electrode portion is connected to the ground (i.e., is grounded and a potential thereof is zero), but a voltage of a polarity opposite to the polarity of the voltage applied to the charging means may also be applied to the collecting electrode 200c. That is, the potential of the collecting electrode 200c as the second electrode portion may also be opposite in polarity to the potential of the first electrode 200b1 of the first and second electrodes 200b2 and 200b2 constituting the first electrode portion.

Further, the potential of the collecting electrode 200c as the second electrode portion may also be the same in polarity as the potential of the first electrode 200b1 of the first and second electrodes 200b1 and 200b2 constituting the first electrode portion and may also be a value closer to zero.

Further, in this embodiment, the exhaust duct 200a is all formed of the resin material, but a part of a wall constituting the collecting space 200a2 is formed with a metal component part connected to the ground (grounded). By forming the wall of the collecting space 200a2 with the metal component part, the metal wall can also be used as the collecting electrode, so that a surface area of the collecting electrode can be increased. When the surface area of the collecting electrode is increased, a possibility that the charged UFP approaches the collecting electrode becomes high, so that the collecting efficiency can be enhanced.

Further, in this embodiment, the collecting electrode 200c had the flat plate shape, but may also be provided with projections or bent portion. When the collecting electrode is provided with the projections or the bent portion, the surface area of the collecting electrode can be increased, so that the collecting efficiency can be enhanced for the same reason described above.

### Second Embodiment

Second Embodiment is different from First Embodiment in constitution of the collecting space and is the same as First Embodiment except for this point. Part (a) of FIG. 8 is a longitudinal sectional view of a fixing device 10 and a UFP collecting means 202 in this embodiment in which a branched collecting space is provided, and part (b) of FIG. 8 is a top view of the fixing device 10 and the UFP collecting means 202. In this embodiment, the collecting space 202a2 is branched into a first collecting space 202a21 and a second collecting space 202a22, and the collecting electrode 200c is disposed in each of the first and second collecting spaces 202a21 and 202a22.

The reason why the collecting space 202a2 is branched into the first collecting space 202a21 and the second collecting space 202a22 is that by branch the collecting space into two collecting spaces, even an image forming apparatus in which it is difficult to provide a collecting space having a large cross section can be installed.

When the fan 200d is rotated, the UFP generated in the fixing device 10 passes through the opening 109 and is guided through the suction opening in arrow directions in the exhaust duct 202a. The air containing the guided UFP passes through the charging space 200a1 and thereafter passes through the first collecting space 202a21 and the second collecting space 202a22, so that the UFP is collected, and the air passes through the exhaust opening 200e and is discharged to the outside of the image forming apparatus.

The size of the cross section of the collecting space 202a2 with respect to the air traveling direction is represented by a sum of a size S4 of the cross section of the first collecting space 202a21 and a size S5 of the cross section of the second collecting space 202a22 with respect to the air traveling direction. In this embodiment, the size of the cross section of the collecting space 202a2 was made larger than the size S1 of the cross section of the charging space 200a1 (i.e., S4+S5>S1). As a result, the speed of the UFP passing through the collecting space 202a2 becomes slow, so that an effect similar to that in First Embodiment can be obtained.

Incidentally, the size S4 of the cross section of the first collecting space 202a21 and the size S5 of the cross section of the second collecting space 202a22 may also be not equal to each other.

Further, in this embodiment, a constitution in which the collecting space 202a2 was branched into the two collecting spaces, i.e., the first collecting space 202a21 and the second collecting space 202a22 was employed, but the number of branched collecting spaces may also be three or more.

### Third Embodiment

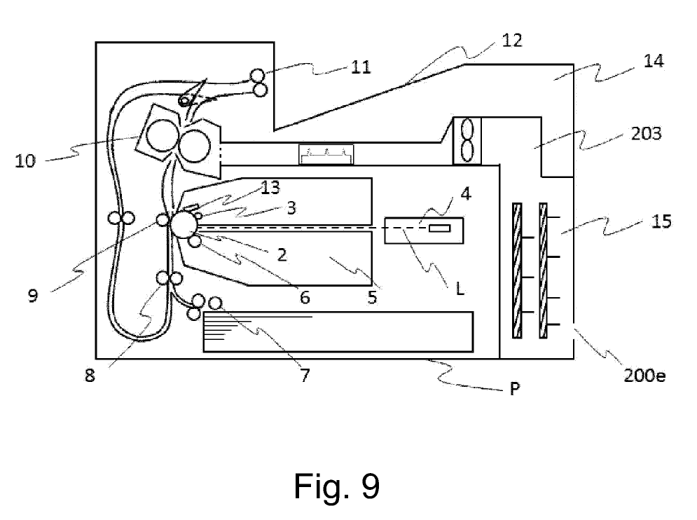

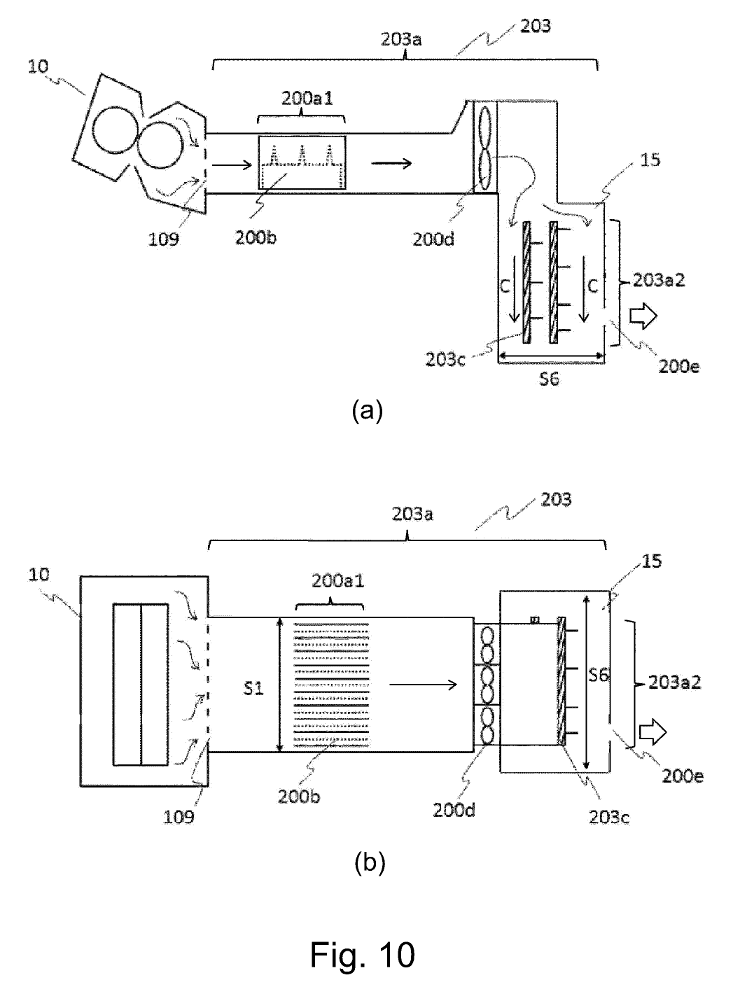

Third Embodiment is different from First Embodiment in that a space (electrical space) in which an electronic circuit board (substrate) in an image forming apparatus is provided and is the same as First Embodiment except for this point. FIG. 9 is a longitudinal sectional view of an image forming apparatus 14 in this embodiment, and an electrical space 15 in which the electronic circuit board is disposed is provided in a space in the neighborhood of the laser beam scanner 4 on a side opposite from a side where the laser light L travels. Incidentally, constitution of the image forming apparatus 14 and the fixing device 10 in this embodiment are same as those in First Embodiment and will be omitted from description.

Part (a) of FIG. 10 is a longitudinal sectional view of a fixing device 10 and a UFP collecting means 203 in this embodiment, and part (b) of FIG. 10 is a top view of the fixing device 10 and the UFP collecting means 203. A collecting space 203a2 is the electronic space 15, and as a collecting electrode 203c, the electronic circuit board disposed in the electrical space 15 is used. The electronic circuit board and electronic component parts mounted thereon is supplied with a voltage or grounded, and therefore the charged UFP can be collected.

In this embodiment, the reason why the already-existing electrical space 15 is used as the collecting space 203a2 in the image forming apparatus 14 is that there is no need to particularly provide the collecting space of the UFP collecting means, and therefore, installation of the UFP collecting means becomes easy. In the case where a temperature of the air flowing into the electrical space 15 is lower than a desired temperature, it is also possible to cool the electronic component parts mounted on the electronic circuit board.

When the fan 200d is rotated, the UFP generated in the fixing device 10 is guided through the suction lattice-like opening 109 in arrow directions in the exhaust duct 203a. The air containing the guided UFP passes through the charging space 200a1 and thereafter passes through the collecting space 203a2, so that the UFP is collected, and the air passes through the exhaust opening 200e and is discharged to the outside of the image forming apparatus.

As the air traveling direction in the collecting space 203a3, a direction of a comprehensive air flow (arrow C direction shown in part (a) of FIG. 10) traveling from the inlet opening to a vent 200e was assumed. Accordingly, a cross section S6 of the collecting space 203a2 with respect to the air traveling direction is a cross section with respect to the arrow C direction. In this embodiment, the size S6 of the cross section of the collecting space 203a2 was made larger than the size S1 of the cross section of the charging space 200a1. As a result, the speed of the UFP passing through the collecting space 203a2 becomes slow, so that an effect similar to that in First Embodiment can be obtained.

### Modified Embodiments

In the above, preferred embodiments of the present invention were described. However, the present invention is not limited to these embodiments, but can be variously modified and changed within the scope of the present invention.

### Modified Embodiment 1

In the above-described embodiments, the constitution in which the image forming apparatus is provided with the UFP collecting means 200 was described, but a constitution in which the fixing device is provided with the UFP collecting means 200 may also be employed.

In the above-described embodiments, heating in the fixing device was made by the heater, but the present invention is not limited thereto and may also use an electromagnetic induction heating type using an exciting coil. In this case, when a back-up member is provided in place of the heater, it is possible to form a nip in a pressed state.

### Modified Embodiment 2

In the above-described embodiments, as the recording material, the recording paper was described, but the recording material in the present invention is not limited to the paper. In general, the recording material is a sheet-like member on which the toner image is formed by the image forming apparatus and includes, for example, regular or irregular materials, such as plain paper, thick paper, thin paper, an envelope, a postcard, a seal, a resin sheet, an OHP sheet, and glossy paper. In the above-described embodiments, for convenience, handling of the recording material (sheet) P was described using terms such as the sheet feeding and the sheet discharge, but by these terms, the recording material in the present invention is not limited to the paper.

### Modified Embodiment 3

In the above-described embodiments, the fixing device for fixing the unfixed toner image on the sheet was described as an example, but the present invention is not limited thereto. The present invention is also similarly applicable to a device for heating and pressing a toner image temporarily fixed on the sheet in order to improve a gloss (glossiness) of an image (also in this case, the device is referred to as the fixing device).

While the present invention has been described with reference to exemplary embodiments, is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-001605 filed on Jan. 10, 2018, which is hereby incorporated by reference herein in its entirety.

What is claimed is:

1. An image forming apparatus comprising:
an image forming portion configured to form a toner image on a recording material;
a fixing portion configured to fix the toner image on the recording material by heating the toner image formed on the recording material;
a flow path including a first space connecting with said fixing portion and a second space connecting with said first space and through which air discharged from said fixing portion passes;
a first electrode portion provided in said first space and provided with a first potential; and
a second electrode portion provided in said second space and provided with a second potential different from the first potential,
wherein an air speed of the air passing through said second space is slower than an air speed of the air passing through said first space.

2. An image forming apparatus according to claim 1, wherein said second electrode portion is grounded, and the second potential is zero.

3. An image forming apparatus according to claim 1, wherein the second potential is opposite in polarity to the first potential.

4. An image forming apparatus according to claim 1, wherein said first electrode portion is provided as a pair of two electrodes opposing each other with respect to a direction crossing an air passing direction.

5. An image forming apparatus according to claim 4, wherein the pair is provided in plurality.

6. An image forming apparatus according to claim 1, further comprising charging means provided in said first space and configured to electrically charge fine particles, contained in the air in said first space, at the first potential of said first electrode portion,
wherein the fine particles are collected by said second electrode portion in said second space.

7. An image forming apparatus according to claim 1, wherein said second space is branched into a plurality of spaces, and said second electrode portion is provided in each of the branched spaces.

8. An image forming apparatus according to claim 1, wherein said second electrode portion is constituted by a metal wall defining said second space.

9. An image forming apparatus according to claim 1, wherein said second electrode portion includes an electrode provided with a projection or a bent portion so as to increase a surface area thereof.

10. An image forming apparatus according to claim 1, further comprising a flow path forming portion provided along a direction crossing a feeding direction of the recording material in said fixing portion.

11. An image forming apparatus comprising:
an image forming portion configured to form a toner image on a recording material;
a fixing portion configured to fix the toner image on the recording material by heating the toner image formed on the recording material;
a flow path including a first space connecting with said fixing portion and a second space connecting with said first space and through which air discharged from said fixing portion passes;
a first electrode portion provided in said first space and provided with a first potential; and
a second electrode portion provided in said second space and provided with a second potential different from the first potential,
wherein a cross sectional area of said second space with respect to a direction perpendicular to a direction of the air entering said second space is larger than a cross sectional area of said first space with respect to a direction perpendicular to a direction of the air entering said first space.

12. An image forming apparatus according to claim 11, further comprising a flow path forming portion provided with a suction opening toward said first opening,
wherein a size of a cross size through which the air passes is larger in said first opening than said suction opening.

13. An image forming apparatus according to claim 11, further comprising a flow path forming portion provided with respect to a feeding direction of the recording material in said fixing portion.

14. An image forming apparatus according to claim 11, wherein said second electrode portion is grounded, and the second potential is zero.

15. An image forming apparatus according to claim 11, wherein the second potential is opposite in polarity to the first potential.

16. An image forming apparatus according to claim 11, wherein said first electrode portion is provided as a pair of two electrodes opposing each other with respect to a direction crossing an air passing direction.

17. An image forming apparatus according to claim 16, wherein the pair is provided in plurality.

18. An image forming apparatus according to claim 11, further comprising charging means provided in said first space and configured to electrically charge fine particles, contained in the air in said first space, at the first potential of said first electrode portion,
wherein the fine particles are collected by said second electrode portion in said second space.
